(19) United States
(12) Patent Application Publication
(10) Pub. No.: US 2026/0111257 A1
(43) Pub. Date: Apr. 23, 2026

(54) STARTING JOBS FOR EVENTS

(71) Applicant: Hewlett Packard Enterprise Development LP, Spring, TX (US)

(72) Inventors: Salil Anil Gokhale, San Jose, CA (US); Maksim Kerper, Atlanta, GA (US); Muthiah Ramanathan Natarajan, Bangalore (IN)

(21) Appl. No.: 19/040,049

(22) Filed: Jan. 29, 2025

(30) Foreign Application Priority Data
Oct. 22, 2024 (IN) 202441080203

(51) Int. Cl. G06F 9/48; G06F 9/445

(52) U.S. Cl. CPC G06F 9/485; G06F 9/44505

(57) ABSTRACT

In some examples, a job management agent in a computing environment receives a registration request to register a job. The job management agent registers the job in mapping information, the job to run in response to an event relating a configuration data item in a configuration store. The mapping information correlates different events to respective different jobs. Based on a notification of the event from a function in a host system, the job management agent accesses the mapping information to identify the job, and starts the job to perform a task relating to the event.

### BACKGROUND

Computing environments may be set up to perform respective workloads associated with different entities, such as different groups of users, different business units of an organization, and so forth. In some examples, computing environments are provided in a cloud, and the computing environments are accessible by tenants of the cloud. In other examples, computing environments are deployed on premises of an organization.

### BRIEF DESCRIPTION OF THE DRAWINGS

Some implementations of the present disclosure are described with respect to the following figures.

FIG. 1 is a block diagram of an arrangement including a host cluster and multiple virtual clusters (vClusters), in accordance with some examples.

FIG. 2 is a block diagram of an arrangement including a host cluster and a new vCluster, according to some examples.

FIG. 3 is a message flow diagram of a process involving a user interface (UI), a host cluster, and a vCluster, according to some examples.

FIG. 4 is a block diagram of a storage medium storing machine-readable instructions according to some examples.

FIG. 5 is a block diagram of a system according to some examples.

FIG. 6 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Computing environments set up on premises of an organization refer to computing environments deployed using a computing infrastructure of the organization. Such computing environments may be self-managed by the organization, as compared to cloud computing environments that may be managed by a cloud provider. Self-management of computing environments may mean that various tools that may be available in a cloud are not available to manage the on-premises computing environments deployed of the organization.

In some examples, the organization may deploy a configuration store containing configuration data items, such as certificates containing secrets to be used for secure operations, configuration settings, configuration information for applications, or any other data items relating to configuring devices or programs. Some configuration data items may change in response to user requests. For example, certificates may be updated, added, or deleted. A challenge faced by on-premises computing environments is that tools for managing changes of configuration data items (or more generally, data items) may not be readily available.

In some cases, a vendor that developed the system (including hardware and machine-readable instructions) to establish the on-premises computing environments is different from the organization for which the on-premises computing environments were established. The vendor may not be familiar with specific rules or criteria of the organization relating to how data item updates are to be managed. As a result, the vendor may not be able to easily develop the tools for managing data item updates or other events.

In accordance with some implementations of the present disclosure, a job management agent can be deployed in a computing environment (e.g., an on-premises computing environment) to allow an organization operating the computing environment to define jobs to run in response to events, such as events including data item changes, events relating to configuration data items in a configuration store, or other events. In some examples, an event relating to a configuration data item in the configuration store can include an event generated from a change of the configuration data item. In other examples, an event relating to a configuration data item in the configuration store can include an event generated from another activity involving the configuration data item, such as a read of the configuration data item, an operation involving the configuration data item, and so forth. The job management agent presents an interface, such as an application programming interface (API) or another type of interface, to allow users of the organization to register, with the job management agent, jobs to run to manage events such as data item changes or events relating to configuration data items. In response to a job registration request, the job management agent can register a job in mapping information that correlates different jobs to different events. When an event is detected, a notification of the event can be propagated to the job management agent. In response, the job management agent accesses the mapping information to identify a job to run. The job management agent then starts the job in the computing environment to perform a task relating to the event, e.g., the job handles the change of the data item, or the job handles an activity involving a configuration data item.

If multiple computing environments are set up, then each computing environment can execute a respective separate job management agent that can register jobs for respective events. In some examples, the multiple computing environments can include virtual clusters (vClusters) of containers that are established in a physical host system. An example of the physical host system is a physical cluster (also referred to as a “host cluster”) that includes computing nodes in which containers are run. An example of a host cluster is a Kubernetes cluster. A “virtual cluster” or “vCluster” refers to a virtualized arrangement of containers that collectively can perform one or more workloads using resources of the host cluster.

In some examples, the organization operating the computing environments can define its own jobs to handle events such as data item changes. The jobs can be specified in job files that are stored in an object store. For example, the job files can include YAML (YAML Ain′t Markup Language) files, or other types of objects. Generally, a job file includes machine-readable instructions that when executed perform a job. A job can refer to a Kubernetes job, or to any other type of job. A job includes a collection of workloads (a single workload or multiple workloads).

Examples of jobs that may be initiated in response to changes in configuration data items can include any or some combination of the following: a job to apply a configuration change represented by a changed configuration data item in a computing environment, a job to check that the configuration change is valid or authorized, a job to check that an entity requesting the configuration change is authenticated, or any other jobs relating to configuration data items or other types of data items.

If the vendor that developed the system to establish the computing environments is different from the organization, the vendor does not have to concern itself with also developing the tools for handling events relating to data items. Rather, the vendor can supply the job management agent that can be deployed in each computing environment that the organization, and the organization can use the job management agent to register jobs for handling the events.

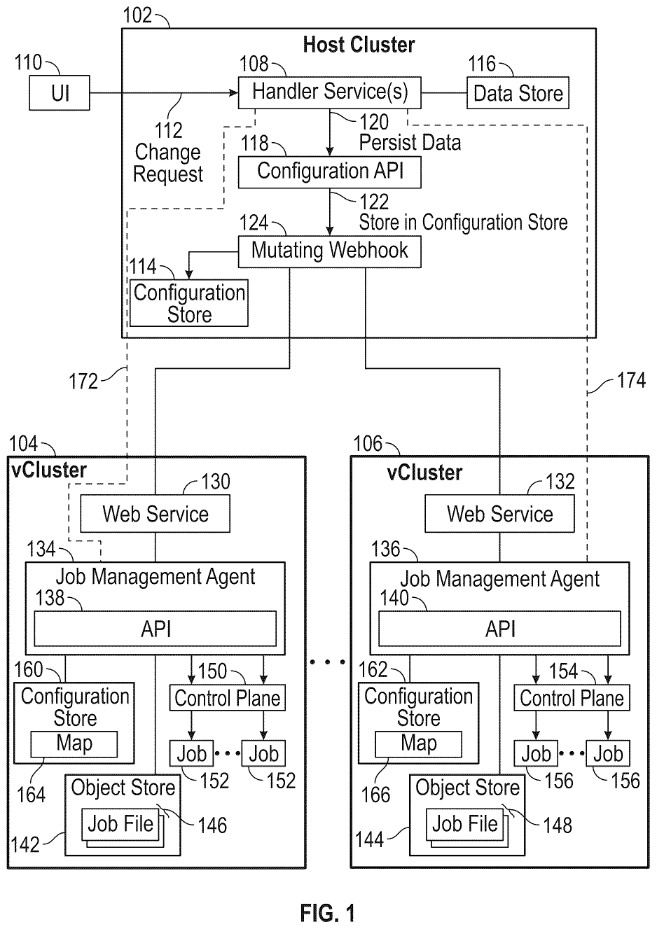

FIG. 1 is a block diagram of an example arrangement that includes a host cluster 102 and multiple vClusters 104 and 106. A vCluster is deployed on the host cluster 102, and when executed, the vCluster uses resources of the host cluster 102. The resources of the host cluster 102 include processing resources, storage resources, communication resources, and/or other types of resources. Although reference is made to a host cluster and vClusters in some examples, more generally, one or more computing environments can be set up in a host system. The host cluster 102 is an example of the host system, and a vCluster is an example of a computing environment. Other examples of computing environments can include virtual machines (VMs), program processes, and so forth.

In examples where the host cluster 102 and the vClusters 104 and 106 are operated by an organization (e.g., a business, an education organization, a government agency, or any other type of organization), the vClusters 104 and 106 can be associated with different users or groups of users, or different business units (e.g., departments of the organization), or other entities of the organization. The vClusters 104 and 106 can execute jobs in environments that are isolated from one another. In other words, jobs executing in the vCluster 104 are isolated from jobs executing in the vCluster 106. In other examples, jobs in one vCluster can interact with jobs in another vCluster.

The host cluster 102 includes a handler service 108 (or multiple handler services). A “handler service” can refer to any service (e.g., implemented with machine-readable instructions) that is able to handle requests to perform actions in response to the requests. Requests may be received by the handler service 108 from a user interface (UI) 110, a program, or a machine. The UI 110 may be part of a web browser, or alternatively, the UI 110 can include a command line interface (CLI). In response to a user input in the UI 110, the UI 110 can issue a change request 112 to the handler service 108.

In some examples, the change request 112 can request a change of a configuration data item in a configuration store 114 of the host cluster 102. In some examples, the configuration store 114 includes a Kubernetes ConfigMap, which an API object to store data as key-value pairs. More generally, a configuration store 114 is a data repository of configuration data items.

A “change” of a data item can refer to updating the data item, adding the data item, or deleting the data item. A “change” of the data item can also include any other operation applied on the data item that would cause a behavior or property of the data item to change. In other examples, a change request submitted to the handler service 108 can relate to a data item stored in another data store 116 that is different from the configuration store 114. For example, the data store 116 may store non-configuration data items, such as database tables, user files, or any other data items unrelated to configuring programs or machines.

In further examples, the handler service 108 may receive requests that do not involve changes of data items. For example, requests may include a request to read a configuration data item from the configuration store 114, a request to perform an operation using a configuration data item from the configuration store 114, or any other type of request that involves data items from the configuration store 114 and/or the data store 116.

In response to the change request 112, the handler service 108 issues a persist data command 120 to a configuration API 118 for persisting data (e.g., a configuration data item) associated with the change request 112. A “command” can refer to a message, an information element, or any other indicator that requests a given action.

The configuration API 118 includes a collection of routines that can be invoked to request different actions. The persist data command 120 can be issued by the handler service 108 by invoking a specific routine of the configuration API 118. In some examples, the configuration API 118 is included as part of a cluster configuration discovery service (CCD). In other examples, the configuration API 118 can be replaced with a different type of interface.

The persist data command 120 sent from the handler service 108 to the configuration API 118 specifies that a changed configuration data item is to be written to the configuration store 114. In response to the persist data command 120, the configuration API 118 issues, to a mutating webhook 124, a store command 122 to write the changed configuration data item to the configuration store 114. The mutating webhook 124 is a Kubernetes service that allows for modification of resources. In other examples, instead of using the mutating webhook 124, a different type of function (e.g., implemented with machine-readable instructions) can be used for managing configuration data item changes in the configuration store 114 (or for managing other events). The mutating webhook 124 or another type of function can also issue notifications of configuration data item changes (or other events) to other entities, including the vClusters 104 and 106.

In the example of FIG. 1, each vCluster 104 or 106 includes a respective web service 130 or 132. The mutating webhook 124 interacts with the web services 130 and 132 in the respective vClusters 104 and 106. More specifically, the mutating webhook 124 can propagate events to the vClusters 104 and 106 through the web services 130 and 132. A standardized protocol can be used to interact with a web service. For example, the standardized protocol can include the Hypertext Transfer Protocol (HTTP) or any other type of protocol. Although FIG. 1 shows the use of web services, in other examples, the mutating webhook 124 can interact with other types of services in the vClusters 104 and 106.

Each vCluster 104 or 106 includes a respective job management agent 134 or 136 (e.g., implemented with machine-readable instructions), which performs job management according to some examples of the present disclosure. The job management agent 134 or 136 is used to register jobs to execute in response to certain events. Additionally, in response to detecting an event, the job management agent can take action to invoke one or more jobs for the event.

In some examples, the job management agent 134 includes a job management API 138, and similarly, the job management agent 136 includes a job management API 140. The job management API 138 or 140 is accessible by an entity to register jobs in the corresponding vCluster 104 or 106. For example, the job management API 139 or 140 includes a registration routine that can be invoked to perform registration of a job. The entity that can register jobs can include a user, a program, or a machine. In some examples, the entity that registers a job with a vCluster is associated with the organization that operates the host cluster 102 and the vClusters 104 and 106. Developers of the organization can create jobs that are used to handle configuration data item changes as well as other events. Jobs for handling events can also be developed by other developers, including developers of a vendor of the system (including the physical infrastructure and/or software and firmware) used to deploy the host cluster 102 and the vClusters 104 and 106. The vendor that provided the system to deploy the host cluster 102 and the vClusters 104 and 106 may be different from the organization operating the host cluster 102 and the vClusters 104 and 106.

In response to a request to register a job, the job management agent 134 or 136 adds a job file for the job to a respective object store 142 or 144 in the respective vCluster 104 or 106. As shown in FIG. 1, the object store 142 contains job files 146 that include program code that when invoked performs a respective job. Similarly, the object store 144 stores job files 148. An example of a job file is a YAML file. In other examples, job files can have other formats. An “object store” can refer to any data store that can store various types of objects, such as files or other types of objects.

The vCluster 104 further includes a control plane 150, such as a Kubernetes control plane or another type of control plane. The job management agent 134 can issue requests to the control plane 150 to start respective jobs 152. The control plane 150 is responsible for performing various control functions for the vCluster 104. Similarly, the vCluster 106 includes a control plane 154 that the job management agent 136 can interact with to start jobs 156 in the vCluster 106.

In some examples, a Kubernetes control plane includes a Kubernetes API with which the job management agent 134 or 136 can interact with to create a job object (based on a job file) for a job. In response to the creation of the job object, a Kubernetes job controller creates a pod (including one or more containers), and a Kubernetes scheduler assigns the pod to a computing node based on various factors. In other examples, other types of control planes that are able to start jobs can be employed.

Each vCluster 104 or 106 also includes a respective configuration store 160 or 162. An example of the configuration store 160 or 162 is a Kubernetes ConfigMap. In other examples, other types of data stores can be used as the configuration store 160 or 162.

In some examples, each configuration store 160 or 162 includes event-job mapping information that correlates events to job files. The configuration store 160 includes event-job mapping information 164, and the configuration store 162 includes event-job mapping information 166.

The event-job mapping information 164 or 166 can include multiple entries, where an entry contains information identifying an event (e.g., a configuration data item change event or another type of event) and a respective job file (or multiple job files) that is (are) to be invoked in response to the event. The event-job mapping information 164 or 166 can be in the form of a table or any other data structure. In some examples, an entry of the event-job mapping information can correlate a name of a data item (e.g., a configuration data item) to one or more jobs to be executed to handle an event relating to the data item.

The event-job mapping information 164 in the vCluster 104 correlates events to respective job files 146 in the object store 142. Similarly, the event-job mapping information 166 in the vCluster 106 correlates events to respective job files 148 in the object store 144.

In addition to storing event-job mapping information, a configuration store in a vCluster can further store configuration data items related to the vCluster. For example, the configuration store 160 in the vCluster 104 stores configuration data items related to the vCluster 104, and the configuration store 162 in the vCluster 106 stores configuration data items related to the vCluster 106. Note that the configuration store 114 in the host cluster 102 can include configuration data items for all vClusters deployed on the host cluster 102.

In some examples, a job is associated with environment variables, such as CONFIG_OPERATION and CONFIG_NAME. The environment variable CONFIG_OPERATION identifies the operation applied to a configuration data item that would trigger the job, where the operation can include a create operation (to create the configuration data item that is to be newly added to a configuration store), an update operation (to update an existing configuration item in the configuration store), a delete operation (to delete an existing configuration item in the configuration store), or a connect operation (to connect configuration data items with respect to one another so that the configuration data items are related). The environment variable CONFIG_NAME specifies the name (or another identifier) of the configuration data item that is subject to the operation specified by CONFIG_OPERATION. Although some examples refer to specific variables associated with jobs, in other examples, other or additional variables may be associated with jobs.

The following is an example of a command to register a job in an object store (e.g., 142 or 144):

```
curl -X POST http://<job-management-agent IP or hostname>
    :v1/configs/myConfig/actions \
  -H “Content-Type: multipart/form-data” \
  -F “file-@job.yam1 \
  -F “jobname=myJob”
```

The above example command is a curl command, or client uniform resource locator (URL) command. A curl command is used to exchange data using a URL. In other examples, other types of commands can be used to register a job in the object store.

In the example command, “job-management-agent IP or hostname” represents an Internet Protocol (IP) address or a hostname of a job management agent (e.g., 134 or 136), “myConfig” represents a configuration data item, and “myJob” represents a job file (e.g., a YAML job file) specifying the job to be started in response to an event (e.g., a change event) relating to the configuration data item.

In further examples, a handler service 108 may interact directly with the job management agent 134 in the vCluster 104 over a path 172, or with the job management agent 136 in the vCluster 106 over a path 174. Paths 172 and 174 bypass the configuration API 118. The handler service 108 may send data of the data store 116 to the job management agent 134 or 136 without passing through the configuration API 118. For example, the data of the data store 116 may include private data that should not be exposed to the configuration API 118. The event-job mapping information 164 or 166 in the vCluster 104 or 106, respectively, can correlate events for private data to respective job files in the object store 142 or 144. Jobs can thus be started for such private data based on the correlation.

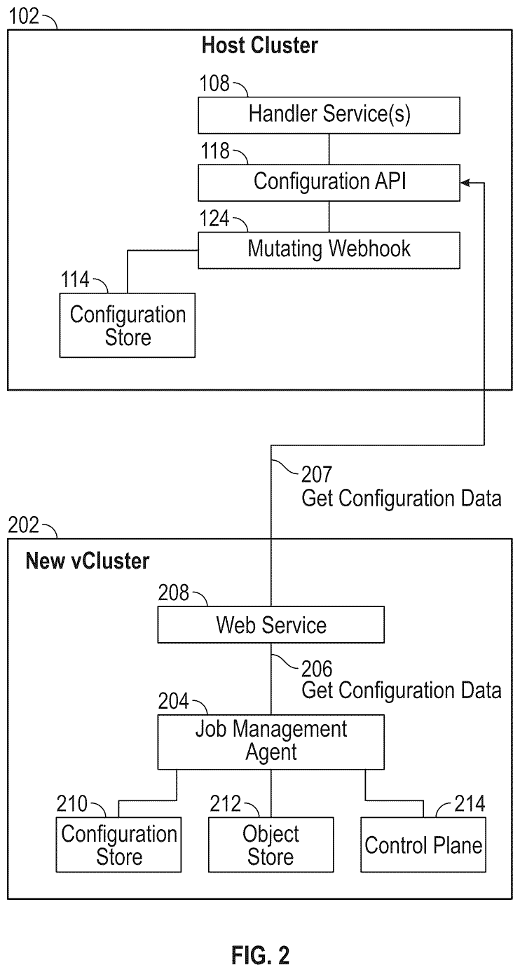

FIG. 2 is a block diagram of an example arrangement including the host cluster 102 and a new vCluster 202, which may be in addition to any other vClusters that may previously have been deployed. Upon creation of the new vCluster 202, bootstrapping of the new vCluster 202 is performed.

Bootstrapping the new vCluster 202 refers to initializing the new vCluster 202 with configuration data. For example, a job management agent 204 in the new vCluster 202 can issue a Get Configuration Data command 206 to a web service 208 of the new vCluster 202. In response, the web service 208 forwards a Get Configuration Data command 207 to the configuration API 118 of the host cluster 102 (such as by calling a routine of the configuration API 118 to retrieve configuration data items relevant to the new vCluster 202). In response, the configuration API 118 obtains a subset of the configuration data items in the configuration store 114 of the host cluster 102, wherein the subset includes those configuration data items that are relevant to the new vCluster 202. The subset excludes configuration data items for other vClusters.

The configuration API 118 provides the subset of configuration data items to the new vCluster 202. The job management agent 204 receives the subset of configuration data items from the host cluster 102, and the job management agent 204 adds the received configuration data items to a configuration store 210 of the new vCluster 202. The new vCluster 202 also includes an object store 212 to store job files when registered with the job management agent 204. Additionally, the new vCluster 202 includes a control plane 214 for the new vCluster 202.

At a later time, in response to requests to register jobs for events received by the job management agent 204, the job management agent 204 can create an event-job mapping information that correlates events to job files.

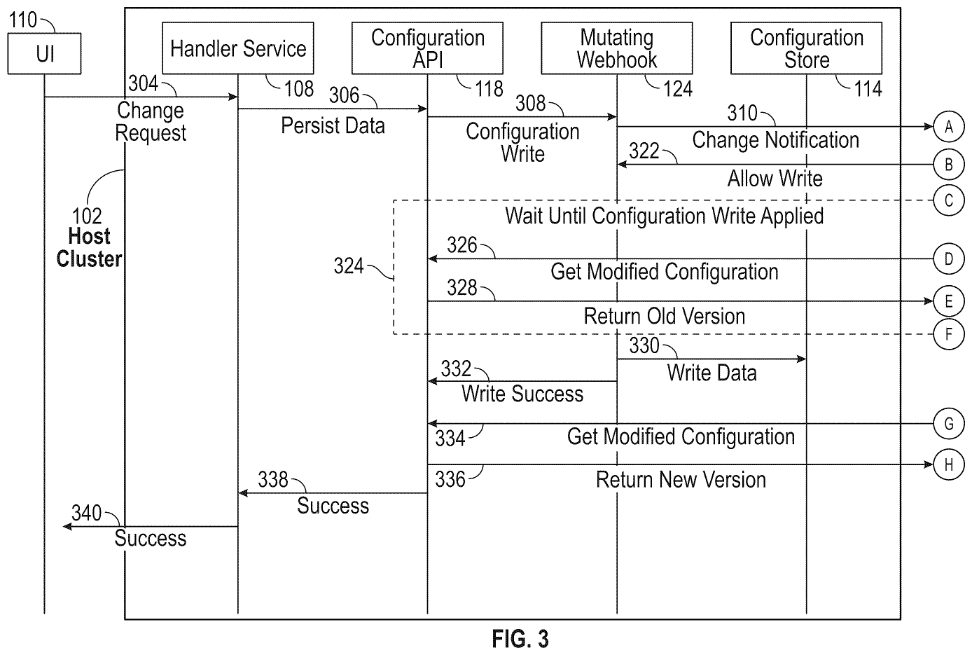

FIG. 3 is a message flow diagram of a process involving the UI 110, the host cluster 102, and a vCluster 302, which can be any of the vClusters 104, 106, and 202 shown in FIG. 1 or 2. Although FIG. 3 shows just one vCluster 302, note that there may be multiple vClusters in some examples.

The UI 110 sends (at 304) a change request to the handler service 108 in the host cluster 102. The change request can be a request to change (e.g., update, add, delete, or connect) a configuration data item. In response to the change request, the handler service 108 issues (at 306) a persist data command to the configuration API 118.

In response to the persist data command, the configuration API 118 sends (at 308) a configuration write command to the mutating webhook 124. Based on receiving the configuration write command, the mutating webhook 124 sends (at 310) a change notification to a web service 312 of the vCluster 302. The web service 312 is similar to the web service 130, 132, or 208 of FIG. 1 or 2. The change notification can be in the form of a message, an information element, or another type of indicator.

In addition to the web service 312, the vCluster 302 includes a job management agent 314 (similar to the job management agent 134, 136, or 204 of FIG. 1 or 2), a configuration store 316 (similar to the configuration store 160, 162, or 210 of FIG. 1 or 2), an object store 318 (similar to the object store 142, 144, or 212 of FIG. 1 or 2), and a control plane 320 (similar to the control plane 150, 154, or 214 of FIG. 1 or 2).

In response to the change notification, the web service 312 can determine whether to allow or deny the write of the configuration data item to occur. If the web service 312 determines that the configuration data item write is to be denied, the web service 312 can return an error indication to the mutating webhook 124, which results in the change of the configuration data item not being persisted.

However, if the web service 312 determines that the configuration data item write is allowed, the web service 312 sends (at 322) an allow write indication (e.g., a message, an information element, or another indicator) to the mutating webhook 124, to allow the write of the configuration data item.

The configuration API 118 and the web service 312 then perform a loop 324 to wait for the configuration data item write to be completed by the mutating webhook 124. In an example where there are multiple vClusters, the configuration data item write is not performed to the configuration store 114 until all vClusters have been notified of the change. During the loop 324, the web service 312 repeatedly sends (at 326) a Get Modified Configuration command to the configuration API 118. The Get Modified Configuration command is a request to obtain the changed configuration data item. The repeated sending of the Get Modified Configuration command can be performed by the web service 312 after a retry time interval, which can exponentially increase with the number of attempts. Until the mutating webhook 124 has completed the write of the changed configuration data item, the configuration data item retrieved from the configuration store 114 is the old version of the configuration data item (as indicated by version information of the configuration data item). The “old version” of the configuration data item is the version of the configuration data item prior to the change requested by the change request received from the UI 110. The configuration API 118 returns (at 328) the old version of the configuration data item to the web service 312.

At some point (such as after all vClusters have been notified of the change), the mutating webhook 124 completes the write (at 330) of the changed configuration data item to the configuration store 114. When the mutating webhook 124 completes the write of the changed configuration data item to the configuration store 114, the mutating webhook 124 sends (at 332) a write success indication to the configuration API 118.

When the web service 312 next sends (at 334) the Get Modified Configuration command to the configuration API 118 (after a retry time interval), the configuration data item retrieved from the configuration store 114 is the new version (i.e., the version corresponding to the change requested by the change request). The configuration API 118 returns (at 336) the new version of the configuration data item to the web service 312. The new version is indicated by version information returned with the configuration data item. The web service 312 can detect the new version based on the version information.

Further, in response to the write success indication from the mutating webhook 124, the configuration API 118 sends (at 338) a success indication to the handler service 108, which forwards (340) the success indication to the UI 110. The success indication provides an indication to a user that the requested change of the configuration data item has successfully completed.

Upon receipt of the new version of the changed configuration data item, the web service 312 provides (at 342) the name and version of the changed configuration data item to the job management agent 314. More generally, the web service 312 provides, to the job management agent 314, information of an event relating to the changed configuration data item.

In response to the event, the job management agent 314 obtains (at 344), from the configuration store 316, a job file path that refers to a location of a job file for the job that is to be started in response to the event, in this case the requested change of the configuration data item. An example of a job file path includes a URL, a storage address, or any other information identifying a location of the job file. The job management agent 314 sends a request to the configuration store 316 to obtain the job file path. The configuration store 316 performs a lookup of an event-job mapping information in the configuration store 316, which correlates the event to a job file. The configuration store 316 returns the job file path of the job file to the job management agent 314.

In response to receiving the job file path from the configuration store 316, the job management agent 314 obtains (at 346) the job file from the object store 318. The job management agent 314 sends a request containing the job file path to the object store 318. In response to the request, the object store 318 returns the job file to the job management agent 314.

Once the job file is obtained, the job management agent 314 issues (at 348) a start job command to the control plane 320. For example, if the control plane 320 is a Kubernetes control plane, the start job command includes a job object created based on the job management agent 314 interacting with the Kubernetes API of the Kubernetes control plane. Other components, e.g., including the Kubernetes job controller and Kubernetes scheduler, will then complete the process of the starting the job. In response to the start job command, the control plane 320 starts execution of the job. The control plane 320 then sends (at 350) a success indication indicating that the job has been successfully started.

The following are examples of job management commands that may be issued to a job management agent (e.g., 134, 136, 204, or 314 in FIG. 1, 2, or 3) for managing jobs. A configuration list command can be issued to the job management agent to identify all configuration data items for which the job management agent is to launch jobs as a response to events relating to the configuration data items.

An example of the configuration list command is set forth below:

$$curl http \text{://} < job - management - agent IP or hostname > : v 1 / configs .$$

In response to the configuration list command, the job management agent generates a list of the events as a response to the command. A “list” can refer to any information that can identify multiple items, such as events or other types of items.

A job list command can be issued to the job management agent to identify one or more jobs that are registered on a particular event. An example of the job list command is set forth below:

curl http://<job-management-agent IP or hostname>:
v1/configs/myConfig/actions.

In response to the configuration list command, the job management agent generates a list of jobs that are registered to be invoked in response to a change of a configuration data item identified by myConfig. The list of jobs can identify the jobs.

A delete job command can be issued to the job management agent to delete a job that was previously registered. An example of the delete job command is set forth below:

curl -X DELETE http://<job-management-agent IP or hostname>
v1/configs/myConfig/actions/myJob

The above example delete job command deletes a job identified by myJob. Deleting a job results in the corresponding job file being removed from an object store (e.g., 142, 144, 212, or 318 in FIG. 1, 2, or 3).

An aggregate status command can be issued to the job management agent to obtain a collective (aggregate) status of a collection of jobs that have been invoked in a vCluster in response to an event. An example of the aggregate status command is set forth below:

curl http://<job-management-agent IP or hostname>:
v1/configs/myConfig/run

The above example aggregate status command requests the aggregate status of the collection of jobs launched in response to a change of a configuration data item identified by myConfig. The “aggregate status” refers to a combination of the statuses of all jobs in the collection of jobs. If all jobs in the collection of jobs run successfully to completion, then the aggregate status returns a success indication. However, if any job in the collection of jobs fails to complete, then the aggregate status returns a failure indication.

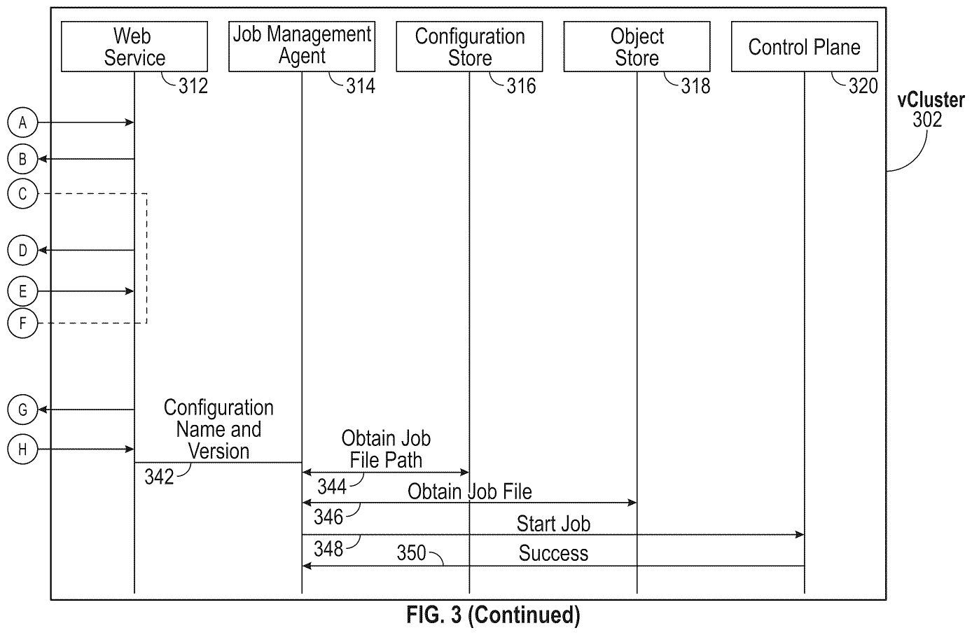

FIG. 4 is a block diagram of a non-transitory machine-readable or computer-readable storage medium 400 storing machine-readable instructions that upon execution cause a system to perform various tasks. The system can include one or more computers, and can include a host cluster and one or more virtual clusters, such as shown in FIG. 1.

The machine-readable instructions include job registration request receipt instructions 402 to receive, at a job management agent in a computing environment, a registration request to register a job. The job management agent may be the job management agent 134, 136, 204, or 314 of FIG. 1, 2, or 3. The computing environment may be deployed in a host system. The computing environment may include a virtual computing environment, or another type of computing environment.

The machine-readable instructions include job registration instructions 404 to register, by the job management agent in mapping information of a configuration store, the job that is to run in response to an event comprising a change of a data item in a data store. The mapping information correlates different events to respective different jobs. Examples of the mapping information include the event-job mapping information 164 or 166 of FIG. 1.

The machine-readable instructions include event notification instructions 406 to receive, from a function in a host system including the data store, a notification of the event. An example of the function can be the mutating webhook 124 of FIG. 1, for example. As another example, the function can include a handler service 108.

The machine-readable instructions include mapping information access instructions 408 to, based on the notification, access, by the job management agent, the mapping information to identify the job. For example, a service (e.g., a web service) in the computing environment can provide a name of the data item to the job management agent, which uses the data item name to retrieve an entry from the mapping information that maps the data item to the job.

The machine-readable instructions include job starting instructions 410 to start, by the job management agent, the job to perform a task relating to the event. The job starting instructions 410 can issue a request to a control plane (e.g., 150 or 154 in FIG. 1) to start the job.

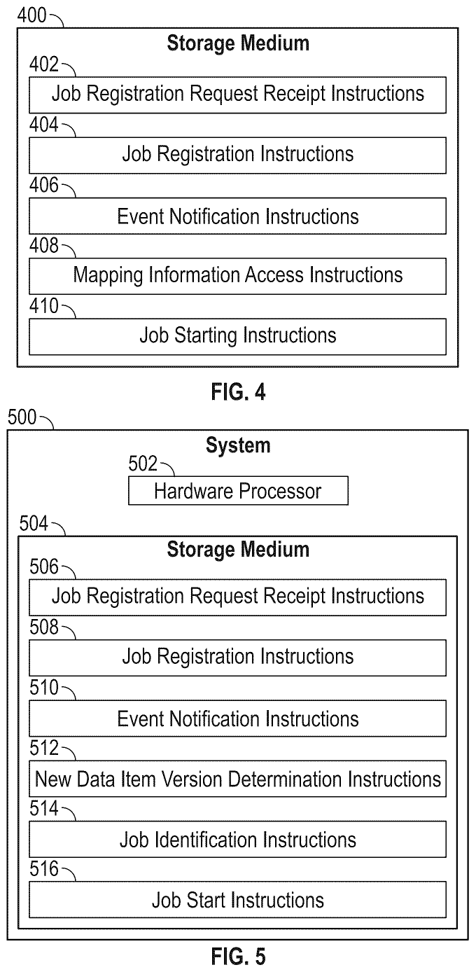

FIG. 5 is a block diagram of a system 500 according to some examples of the present disclosure. The system 500 can be implemented with one or more computers.

The system 500 includes a hardware processor 502 (or multiple hardware processors). A hardware processor can include a microprocessor, a core of a multi-core microprocessor, a microcontroller, a programmable integrated circuit, a programmable gate array, or another hardware processing circuit.

The system 500 includes a non-transitory machine-readable or computer-readable storage medium 504 storing machine-readable instructions executable on the hardware processor 502 to perform various tasks. Machine-readable instructions executable on a hardware processor can refer to the instructions executable on a single hardware processor or the instructions executable on multiple hardware processors.

The machine-readable instructions include job registration request receipt instructions 506 to receive, at a job management agent in a virtual computing environment on a host system, a registration request to register a job. The virtual computing environment can be a vCluster deployed on a physical cluster (e.g., a Kubernetes cluster), for example.

The machine-readable instructions include job registration instructions 508 to register, by the job management agent in mapping information of a configuration store, the job that is to run in response to an event comprising a change of a data item in a data store, where the mapping information correlates different events to respective different jobs. Examples of the mapping information include the event-job mapping information 164 or 166 of FIG. 1.

The machine-readable instructions include event notification instructions 510 to receive, from a function in a host system comprising the data store, a notification of the event. The function can be the mutating webhook 124 of FIG. 1, for example.

The machine-readable instructions include new data item version determination instructions 512 to, based on the notification, determine whether a new version of the data item is received. The new version of the data item includes the data item after the change.

The machine-readable instructions include job identification instructions 514 to, based on receipt of the new version of the data item, access, by the job management agent, the mapping information to identify the job. The job management agent can obtain a job file path to retrieve a job file at the job file path.

The machine-readable instructions include job start instructions 516 to start, by the job management agent, the job to perform a task relating to the event. The task can handle the change of the data item.

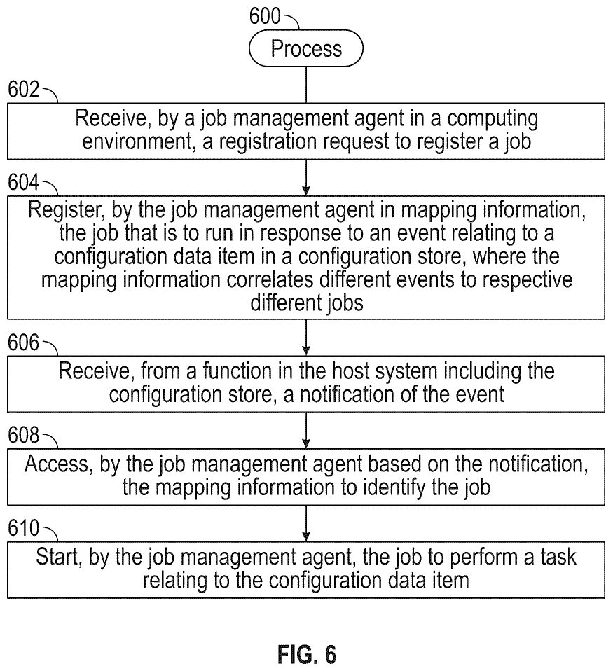

FIG. 6 is a flow diagram of a process 600 according to some examples of the present disclosure. The process 600 may be performed in a computing environment, such as a vCluster or another type of computing environment.

The process 600 includes receiving (at 602), by a job management agent in a computing environment, a registration request to register a job. The registration request may be received at an interface (e.g., an API) of the job management agent, for example.

The process 600 includes registering (at 604), by the job management agent in mapping information, the job that is to run in response to an event relating to a configuration data item in a configuration store. The mapping information correlates different events to respective different jobs. The configuration store can include the configuration store 160, 162, 210, or 316 of FIG. 1, 2, or 3.

The process 600 includes receiving (at 606), from a function in the host system including the configuration store, a notification of the event. The notification may be received at a web service (e.g., 130, 132, 208, or 312 in FIG. 1, 2, or 3) in the computing environment.

The process 600 includes accessing (at 608), by the job management agent based on the notification, the mapping information to identify the job. In some examples, if the event relates to a change of the configuration data item, the job processes the change of the configuration data item.

The process 600 includes starting (at 610), by the job management agent, the job to perform a task relating to the configuration data item.

In some examples, the computing environment is a first computing environment, and the job management agent is a first job management agent in the first computing environment. The function in the host system can further propagate a further notification of the event relating to the configuration data item in the configuration store to a second computing environment. Based on the further notification, a second job management agent in the second computing environment can access mapping information in the second computing environment to identify a further job. The second job management agent starts the further job in the second computing environment to perform a task relating to the configuration data item, such as by calling a control plane in the second computing environment.

In some examples, the first computing environment is isolated from the second computing environment.

In some examples, an interface of the job management agent receives a command to identify events for which the job management agent is to launch jobs as a response to the events. The job management agent generates a list of the events as a response to the command.

In some examples, an interface of the job management agent receives a command to identify jobs registered for the event. The job management agent generates a list of the jobs as a response to the command.

In some examples, an interface of the job management agent receives a command to delete the job registered for the event. The job management agent removes a job file for the job from an object store as a response to the command.

In some examples, an interface of the job management agent receives a command to obtain a status of a plurality of jobs started in response to the event. The job management agent generates an aggregate status corresponding to the plurality of jobs. The aggregate status indicates a successful completion responsive to all of the plurality of jobs successfully completing, or an unsuccessful completion responsive to any of the plurality of jobs not successfully completing.

A storage medium (e.g., 400 in FIG. 4 or 504 in FIG. 5) can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
receiving, by a job management agent in a computing environment, a registration request to register a job;
registering, by the job management agent in mapping information, the job that is to run in response to an event relating to a configuration data item in a configuration store, wherein the mapping information correlates different events to respective different jobs;
receiving, from a function in a host system comprising the configuration store, a notification of the event;
based on the notification, accessing, by the job management agent, the mapping information to identify the job; and
starting, by the job management agent, the job to perform a task relating to the configuration data item.

2. The method of claim 1, wherein the event relates to a change of the configuration data item, and the job processes the change of the configuration data item.

3. The method of claim 1, wherein the registration request is received from a requester through an interface presented by the job management agent.

4. The method of claim 1, wherein the starting of the job comprises the job management agent sending a request to start the job to a control plane.

5. The method of claim 1, wherein the host system comprises a physical cluster of computing nodes, and the computing environment is a virtual cluster established on the physical cluster of computing nodes.

6. The method of claim 1, wherein the computing environment is a first computing environment, and the job management agent is a first job management agent in the first computing environment, and wherein the method further comprises:
propagating, by the function in the host system, a further notification of the event relating to the configuration data item in the configuration store to a second computing environment;
based on the further notification, accessing, by a second job management agent in the second computing environment, mapping information in the second computing environment to identify a further job; and
starting, by the second job management agent, the further job in the second computing environment to perform a task relating to the configuration data item.

7. The method of claim 6, wherein the first computing environment is isolated from the second computing environment.

8. The method of claim 1, further comprising:
receiving, through an interface of the job management agent, a command to identify events for which the job management agent is to launch jobs as a response to the events; and
generating, by the job management agent, a list of the events as a response to the command.

9. The method of claim 1, further comprising:
receiving, through an interface of the job management agent, a command to identify jobs registered for the event; and
generating, by the job management agent, a list of the jobs as a response to the command.

10. The method of claim 1, further comprising:
receiving, through an interface of the job management agent, a command to delete the job registered for the event; and
removing, by the job management agent, a job file for the job from an object store as a response to the command.

11. The method of claim 1, further comprising:
receiving, through an interface of the job management agent, a command to obtain a status of a plurality of jobs started in response to the event; and
generating, by the job management agent, an aggregate status corresponding to the plurality of jobs.

12. The method of claim 11, wherein the aggregate status indicates:
a successful completion responsive to all of the plurality of jobs successfully completing, or
an unsuccessful completion responsive to any of the plurality of jobs not successfully completing.

13. The method of claim 1, wherein files of the different jobs are stored in an object store.

14. A non-transitory machine-readable storage medium comprising instructions that upon execution cause a system to:
receive, at a job management agent in a computing environment, a registration request to register a job;
register, by the job management agent in mapping information of a configuration store of the computing environment, the job that is to run in response to an event comprising a change of a data item in a data store, wherein the mapping information correlates different events to respective different jobs;
receive, from a function in a host system comprising the data store, a notification of the event;
based on the notification, access, by the job management agent, the mapping information to identify the job; and
start, by the job management agent, the job to perform a task relating to the event.

15. The non-transitory machine-readable storage medium of claim 14, wherein the starting of the job comprises the job management agent sending a request to start the job to a control plane.

16. The non-transitory machine-readable storage medium of claim 15, wherein the job management agent and the control plane are part of a virtual cluster.

17. The non-transitory machine-readable storage medium of claim 14, wherein the data item comprises a configuration data item in a configuration store of the host system, and the job processes a change of the configuration data item.

18. The non-transitory machine-readable storage medium of claim 14, wherein the computing environment comprises a virtual cluster executing virtual compute entities on the host system.

19. A system comprising:
a hardware processor; and
a non-transitory storage medium storing instructions executable on the hardware processor to:
receive, at a job management agent in a virtual computing environment deployed on a host system, a registration request to register a job;
register, by the job management agent in mapping information of a configuration store, the job that is to run in response to an event comprising a change of a data item in a data store, wherein the mapping information correlates different events to respective different jobs;
receive, from the host system, a notification of the event;
based on the notification, determine whether a new version of the data item is received, the new version of the data item comprising the data item after the change;
based on receipt of the new version of the data item, access, by the job management agent, the mapping information to identify the job; and
start, by the job management agent, the job to perform a task relating to the event.

20. The system of claim 19, wherein the determining of whether the new version of the data item is received is performed by a service, and wherein the service is to send, to the job management agent, a name of the data item and version information of the new version of the data item.
